(19) United States
(12) Patent Application Publication
(10) Pub. No.: US 2017/0133117 A1
(43) Pub. Date: May 11, 2017

(54) ELECTRIC POWER TRANSMISSION CABLE WITH COMPOSITE CORES

(71) Applicant: NEXANS, Paris (FR)

(72) Inventors: Francis DEBLADIS, Grabels (FR); Stéphane MORICE, LEFOREST (FR)

(21) Appl. No.: 15/323,241

(22) PCT Filed: Jun. 3, 2015
(86) PCT No.: PCT/FR2015/051470

§ 371 Date: Dec. 30, 2016

(30) Foreign Application Priority Data
Jun. 30, 2014 (FR) 14 56112

(51) Int. Cl. H01B 1/24; H01B 5/10; H01B 9/00

(52) U.S. Cl. CPC H01B 1/24; H01B 9/006; H01B 5/105

(57) ABSTRACT

The invention relates to an electric power transmission cable comprising at least one central composite core (1A, 1B) formed of fibers embedded in a resin and around which metal conductive wires (2, 3) are positioned, said core (1) being coated with a coating layer (4) consisting of carbon nanotubes embedded in a resin.

According to the invention, said coating layer consists of only 4% to 8% by weight of carbon nanotubes embedded in said resin.

The invention relates to an electric power transmission cable, in particular an overhead cable, comprising a set of composite cores.

Overhead cables with central composite cores, forming a mechanical support for conductive wires wound around cores consisting of resin-pultruded fibers, are known.

According to patent document JP 3-129606, the unitary cores are formed of resin-pultruded carbon fibers, for example epoxy resin-pultruded carbon fibers, and are covered with a metal foil intended to form a buffer layer for protecting the core, in order to increase its resistance to bending and to impacts, and also to avoid a deterioration of the resin caused by heat. The metal foil may be made of aluminum.

Another advantage of such an aluminum covering foil may be to ensure an electrical conduction that avoids high potential differences between the pultruded composite core or the pultruded composite cores and the conductive wires that surround it (them).

However, this solution is expensive, considering the price of aluminum and the additional manufacturing step that this creates.

Indeed, such an aluminum foil is wound around the core and its edges are welded longitudinally. This results in a manufacturing operation separate from the pultrusion of the core.

Furthermore, known from patent document US 2012/0186851 is a core comprising an inner portion and an outer portion. The inner portion is formed of fibers in a resin and the outer portion is also formed of fibers in a resin, added to which are thermally conductive particles, for example of aluminum, for example with a ratio of 20% to 50% by weight, or of carbon black and/or carbon nanotubes, for example at a ratio of less than 3%.

However, with such a content, although the fillers may have an impact on the mechanical strength, they do not have an electrical effect since this content does not lead to electrical percolation and does not provide electrical conduction between the pultruded composite core or the pultruded composite cores and the conductive wires that surround it (them).

The object of the invention is to ensure an electrical conduction that avoids high potential differences between the pultruded composite core or the pultruded composite cores and the conductive wires that surround it (them), by means of a material that is more economical than aluminum and that is easier to manufacture.

In order to do this, according a first embodiment, the invention proposes an electric power transmission cable comprising at least one central composite core formed of fibers embedded in a resin and around which metal conductive wires are positioned, said core being coated with a coating layer consisting of carbon nanotubes embedded in a resin, wherein said coating layer consists of only 4% to 8% by weight of carbon nanotubes embedded in said resin.

Such a coating layer may be extruded at the same time as the pultrusion of the core and reduces the manufacturing steps.

Preferably, said coating layer comprises 4% by weight of carbon nanoparticles.

Preferably, said resin of said coating layer is an epoxy or polyurethane resin.

Said core is advantageously made of epoxy resin-pultruded carbon fibers.

Said conductive wires are advantageously made of aluminum or of aluminum alloy.

According a second embodiment, the invention proposes an electric power transmission cable comprising at least one central composite core formed of fibers embedded in a resin and around which metal conductive wires are positioned, said core being coated with a coating layer consisting of carbon black embedded in a resin, wherein said coating layer consists of only 20% to 30% by weight of carbon black embedded in said resin.

Such a coating layer may be extruded at the same time as the pultrusion of the core and reduces the manufacturing steps.

Preferably, said coating layer comprises substantially 20% by weight of carbon black.

Preferably, said resin of said coating layer is an epoxy or polyurethane resin.

Said core is advantageously made of epoxy resin-pultruded carbon fibers.

Said conductive wires are advantageously made of aluminum or of aluminum alloy.

The invention is described below in greater detail with the aid of figures that represent preferred embodiments of the invention.

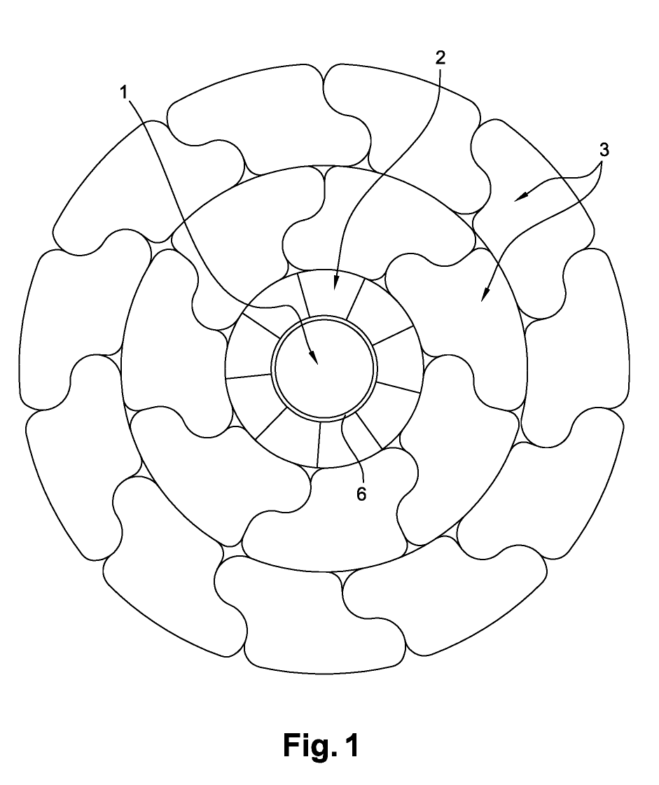

FIG. 1 is a cross-sectional view of a cable in accordance with the invention, according to a first embodiment.

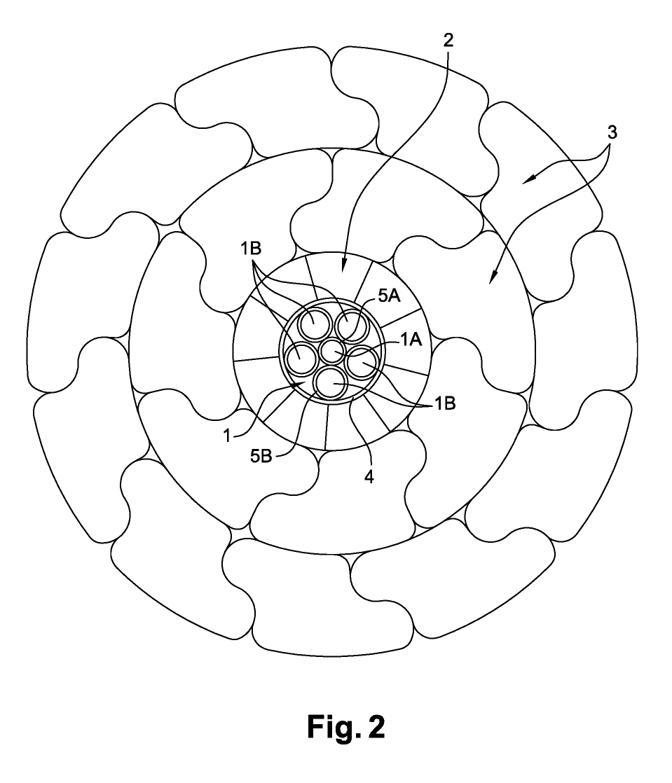

FIG. 2 is a cross-sectional view of a cable in accordance with the invention, according to a second embodiment.

As represented in FIG. 1, an electric power transmission cable comprises a central composite core 1 formed of embedded fibers, preferably resin-pultruded carbon fibers, preferably epoxy resin-pultruded carbon fibers, around which metal conductive wires 2, 3, preferably made of aluminum or aluminum alloy, are positioned.

By way of example, as illustrated, the cable comprises a first inner layer of conductive wires 2 of trapezoidal cross section and two outer layers of wires 3 of Z-shaped cross section wound in the opposite direction. Any combination of conductive wires of circular, trapezoidal and/or Z-shaped cross section may be used according to sizing considerations.

The core 1 is coated with a coating layer 6, which consists of carbon nanotubes or of carbon black embedded in a resin, preferably epoxy or polyurethane resin, with a sufficient content to ensure an electrical conduction between the core 1 and the adjacent metal conductive wires 2. Preferably, the resistivity of the coating layer 6 is less than or equal to 10⁺⁵ Ω·m and, advantageously, substantially equal to 10⁺⁵ Ω·m.

According a first preferred embodiment, the coating layer comprises 4% to 8% by weight of carbon nanoparticles, and preferably substantially 4% by weight.

According a second embodiment, the coating layer consists of only 20% to 30% by weight of carbon black embedded in said resin, and preferably substantially 20% by weight of carbon black.

As illustrated in FIG. 2, according to another embodiment, an electric power transmission cable in accordance with the invention comprises a central assembly 1 of composite unitary cores 1A, 1B formed of fibers embedded in a resin, preferably epoxy resin-pultruded carbon fibers, and around which metal conductive wires 2, 3, advantageously made of aluminum or aluminum alloy, are wound.

The assembly of unitary cores 1 is coated with a first layer 4 and each unitary core 1A, 1B is covered with a second layer 5A, 5B.

This assembly of unitary cores 1 comprises a central unitary core 1A positioned in the longitudinal axis of the cable and around which several other unitary cores 1B, for example six in number, are stranded.

The central unitary core 1A advantageously has a diameter between 1 and 10 mm, preferably substantially equal to 4 mm, and the other unitary cores 1B advantageously have a diameter also between 1 and 10 mm, preferably substantially equal to 5.5 mm.

Preferably, the second layers 5A, 5B consist of carbon nanotubes or carbon black embedded in a resin, preferably epoxy resin, with a sufficient content to ensure an electrical conduction between the cores and the first layer 4 is metallic, preferably made of aluminum. Preferably, the resistivity of the second coating layers 5A, 5B is less than or equal to 10⁺⁵ Ω·m and, advantageously, substantially equal to 10⁺⁵ Ω·m.

According a first preferred embodiment, the coating layer comprises 4% to 8% by weight of carbon nanoparticles, and preferably substantially 4% by weight.

According a second embodiment, the coating layer consists of only 20% to 30% by weight of carbon black embedded in said resin, and preferably substantially 20% by weight of carbon black.

Advantageously, the second layers 5A, 5B have a thickness of less than 1 mm, preferably substantially equal to 0.3 mm.

1. An electric power transmission cable comprising;
at least one central composite core formed of fibers embedded in a resin and around which metal conductive wires are positioned, said core being coated with a coating layer having carbon nanotubes embedded in a resin, wherein said coating layer has only 4% to 8% by weight of carbon nanotubes embedded in said resin.

2. The cable as claimed in claim 1, wherein said coating layer comprises substantially 4% by weight of carbon nanoparticles.

3. The cable as claimed in claim 1, wherein said resin of said coating layer is an epoxy or polyurethane resin.

4. The cable as claimed in claim 1, wherein said core is made of epoxy resin-pultruded carbon fibers.

5. The cable as claimed in claim 1, wherein said conductive wires are made of aluminum or of aluminum alloy.

6-10. (canceled)
